(19) United States
(12) Patent Application Publication
(10) Pub. No.: US 2023/0316497 A1
(43) Pub. Date: Oct. 5, 2023

(54) METHOD FOR DETECTING DEFECTS IN PRODUCTS FROM IMAGES AND SYSTEM EMPLOYING METHOD

(71) Applicant: HON HAI PRECISION INDUSTRY CO., LTD., New Taipei (TW)

(72) Inventors: CHENG-FENG WANG, Kaohsiung (TW); YING-TIEN HUANG, New Taipei (TW); YEN-YI LIN, New Taipei (TW)

(21) Appl. No.: 17/747,156

(22) Filed: May 18, 2022

(30) Foreign Application Priority Data
Mar. 23, 2022 (CN) 202210293814.3

(51) Int. Cl. G06T 7/00; G06T 7/10; G06T 3/40

(52) U.S. Cl. CPC G06T 7/001; G06T 3/40; G06T 7/10; G06T 2207/20021; G06T 2207/20081; G06T 2207/30108

(57) ABSTRACT

A method for detecting apparent defects in images of products acquires an original image of the product. Defects apparent in the original image are automatically detected by an automatic optical detection apparatus. When the original image comprises at least one apparent defect, the original image is cut into at least one partial image centered on the at least one apparent defect. Each partial image contains one defect. By determining whether the at least one partial image indicates a real defect or a false or ghost defect, a result of desired image (for further analysis), or undesired image (for discarding) is output. The original image is deemed a desired image or an undesired image based on the result. A defect detection system applying the method is also disclosed.

### FIELD

The subject matter herein generally relates to manufacturing, and imaging control for detection of defects.

### BACKGROUND

Detection of defects in products is an important part in an industrial manufacture process, such as defects in textile products, and defects in printed circuit boards. Fine defects are hard to detect. Based on a strict standard, dust can be considered as a defect, but this is a ghost defect. A further detection needs to provide for removing the ghost defects, thus a detection accuracy is not optimal.

Thus, there is room for improvement in the art.

### BRIEF DESCRIPTION OF THE DRAWINGS

Implementations of the present disclosure will now be described, by way of example only, with reference to the attached figures.

FIG. 1 is a diagram illustrating an embodiment of a defect detection system according to the present disclosure.

FIG. 2 is a flowchart illustrating an embodiment of a method of detecting defects from images according to the present disclosure.

FIG. 3 is a diagram illustrating an embodiment of an original image showing defects according to the present disclosure.

FIG. 4 is a detail flowchart illustrating an embodiment of the block S260 in the method in FIG. 2 according to the present disclosure.

FIGS. 5A, 5B, and 5C are diagrams illustrating embodiments of partial images with different features according to the present disclosure.

### DETAILED DESCRIPTION

The present disclosure is described with reference to accompanying drawings and the embodiments. It will be understood that the specific embodiments described herein are merely part of all embodiments, not all the embodiments. Based on the embodiments of the present disclosure, it is understandable to a person skilled in the art, any other embodiments obtained by persons skilled in the art without creative effort shall all fall into the scope of the present disclosure.

In general, the word “module,” as used herein, refers to logic embodied in hardware or firmware, or to a collection of software instructions, written in a programming language, for example, Java, C, or assembly. One or more software instructions in the modules may be embedded in firmware, such as an EPROM, magnetic, or optical drives. It will be appreciated that modules may comprise connected logic units, such as gates and flip-flops, and may comprise programmable units, such as programmable gate arrays or processors, such as a CPU. The modules described herein may be implemented as either software and/or hardware modules and may be stored in any type of computer-readable medium or other computer storage systems. The term “comprising” means “including, but not necessarily limited to”; it specifically indicates open-ended inclusion or membership in a so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.”

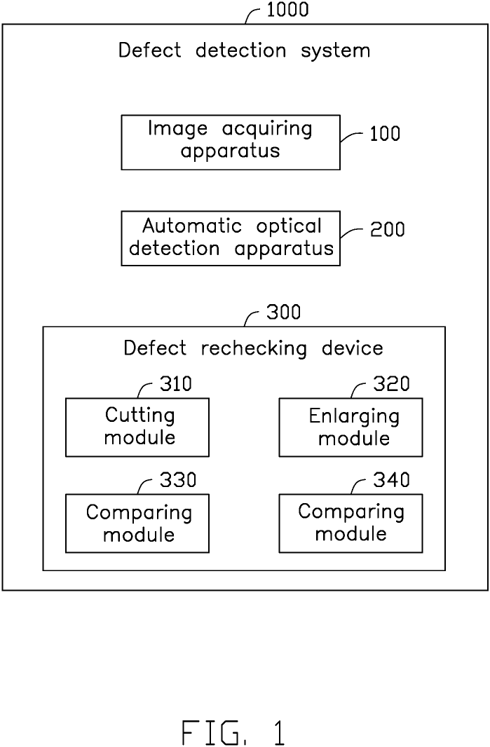

FIG. 1 shows a defect detection system 1000.

The defect detection system 1000 includes an image acquiring apparatus 100, an automatic optical detection apparatus 200, and a defect rechecking device 300.

The image acquiring apparatus 100 scans to-be-detected product to form an original image of the to-be-detected product. For example, the image acquiring apparatus 100 can be a camera. The original image corresponds to a scanned region of the image acquiring apparatus 100. The to-be-detected product can be a plastic container, a packaging paper, a printed circuit board, and a wafer, not being limited thereto. The original image can show part of the to-be-detected product. The image acquiring apparatus 100 transmits the original image of the to-be-detected product to the automatic optical detection apparatus 200.

The automatic optical detection apparatus 200 automatically detects the original image for determining whether the original image includes at least one defect. When there is no defect appearing in the original image, the original image is considered to be a desired image. When the original image includes at least one defect, the original image is considered to be a defective image. The defective image needs to be rechecked. In one embodiment, the automatic optical detection apparatus 200 is an automated optical detector.

The defect rechecking device 300 receives the defective image and rechecks the defective image. In one embodiment, the defect rechecking device 300 can be a computer. The defect rechecking device 300 includes modules for detecting defects according to images. In one embodiment, the defect rechecking device 300 can include a cutting module 310, a defect enlarging module 320, a comparing module 330, and a deep learning module 340.

The cutting module 310 cuts the defective image to form at least one partial image based on the position of the defects. Each partial image includes at least one defect.

The defect enlarging module 320 pre-processes the partial image to enlarge features of the apparent defects in the partial image.

The comparing module 330 receives the enlarged partial image and inputs the enlarged partial image into the deep learning module 340. The deep learning module 340 determines whether the enlarged partial image includes at least one defect based on the features. The deep learning module 340 outputs the result to the comparing module 330. The comparing module 330 rechecks and determines whether the enlarged partial image is a desired image based on the result.

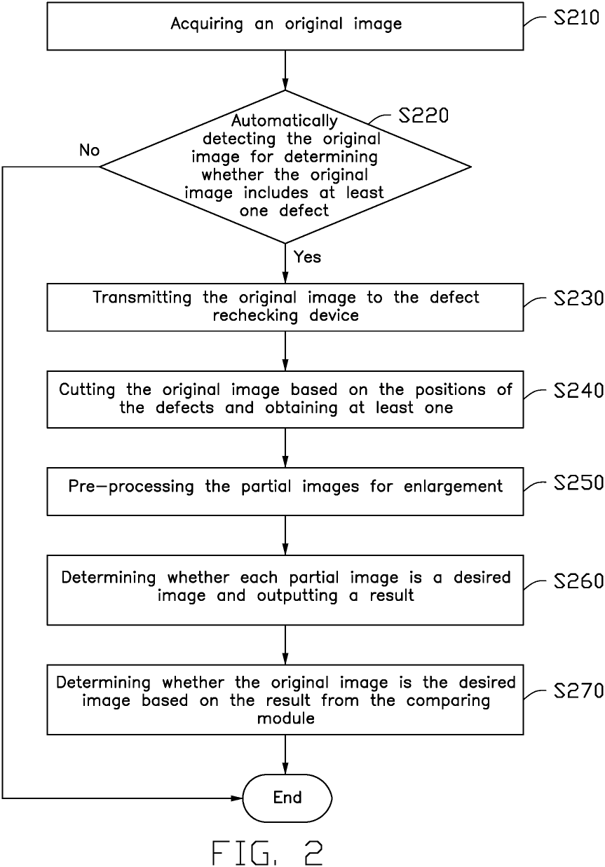

FIG. 2 shows a method for detecting defects in the images used in the defect detecting system 1000, the method may comprise at least the following steps, which also may be re-ordered.

In block S210, an original image is acquired.

In the block S210, the image can be acquired by the image acquiring apparatus 100. The image acquiring apparatus 100 scans to-be-detected product to form the original image of the to-be-detected product.

In block S220, the original image is automatically detected for determining whether the original image includes at least one defect.

In the block S220, the original image is automatically detected by the automatic optical detection apparatus 200 for determining whether the original image includes at least one defect. The image acquiring apparatus 100 transmits the original image to the automatic optical detection apparatus 200 in a wired manner or in a wireless manner.

When the original image includes at least one apparent defect, the original image is considered to be a defective image, and the procedure goes to block S230 for rechecking the original image. When there is no defect apparent in the original image, the original image is considered to be a desired image, and the procedure ends.

In one embodiment, the automatic optical detection apparatus 200 sets a standard for distinguishing defects (such as a size of object in the partial image). For easier identification of the original image with the defects, the standard can be a strict standard (such as when the size of the object in the partial image is less than a standard size, the object is considered as a defect).

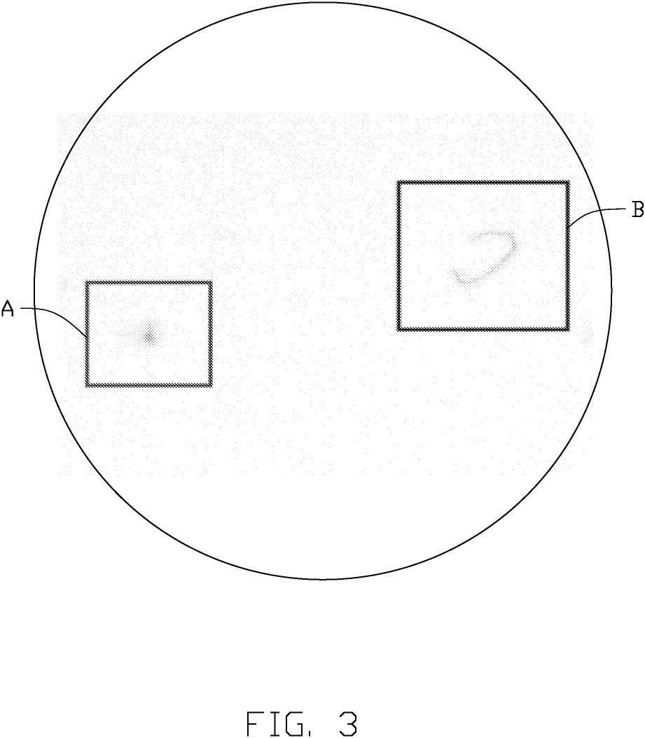

FIG. 3 shows the original image with defects. The original image includes two defects. The defect at position A can be a printing ink, which is a true defect. The defect at position B can be a hair lying on surface of a product, which is a ghost defect. Due to the strict standard, both of the defects at the positions A and B are determined to be defects by the automatic optical apparatus 200. Therefore, the rechecking process is needed.

For distinguishing between the true defect and the ghost defect, the ghost defect includes at least one feature which is a ghost defect, and the true defect includes at least one feature representing a true defect.

In block S230, the original image is transmitted to the defect rechecking device 300 by the automatic optical detection apparatus 200.

In block S240, the original image is cut by the cutting module 310 based on the positions of the defects and at least one partial image is obtained.

Referring to FIG. 3, in the embodiment, the cutting module 310 cuts a region at the position A from the original image as a first partial image and a region at the position B from the original image as a second partial image. Each partial image contains one defect.

In block S250, the partial images are pre-processed for enlargement by the enlarging module 320.

In one embodiment, the partial images are enlarged through an image enhancing manner. For example, the partial images are subtracted from a reference image for removing a background color of the partial images, and the partial images are further de-noised for enhancing the defects.

Due to the size of the defect, the size of the partial image is small. The partial image needs to be pre-processed for enhancing the defects.

In block S260, determining whether each partial image is a desired image by the deep learning module 340, and outputting a result.

The comparing module 330 inputs the processed partial images to the deep learning module 340 for the determination.

In one embodiment, the deep learning module 340 includes a plurality of deep learning models. The deep learning models are used for determining whether each partial image is a desired image.

In block S270, determining whether the original image is the desired image based on the result from the comparing module 330.

In the block S270, when all the partial images are the desired images, the original image is considered as the desired image. When at least one of the partial images is the defective image, the original image is considered as the defective image.

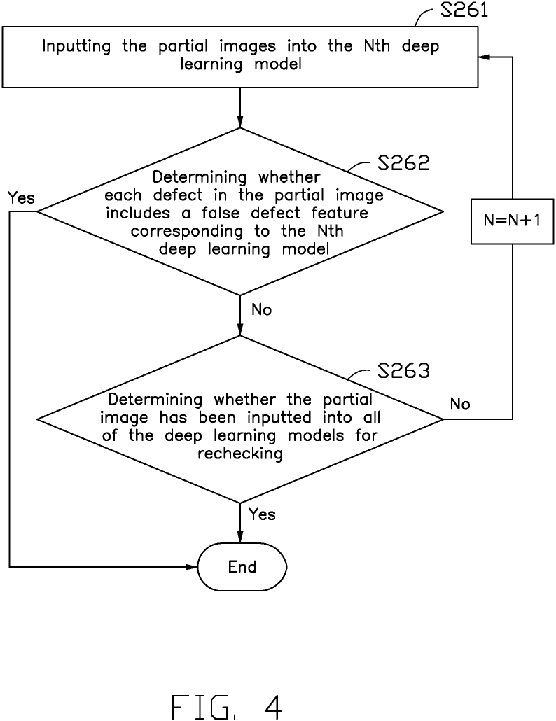

FIG. 4 illustrates a detail flowchart of the block S260. The block S260 further includes the following sub-steps.

In block S261, the partial images are inputted into an Nth deep learning model. N is an integer larger than 1.

The number of the deep learning models can be set based on training samples. The training samples include a plurality of ghost defect features, and the number of the deep learning models is equal to the number of the ghost defect features.

A process for training the deep learning model is:

Firstly, train images for training the model are divided into two categories. In a first category, the training images are defective images (the training images with the defects), and in a second category, the training images show ghost images (the training images with ghost defects). The second category includes a plurality of groups. Each group corresponds to an obviously ghost defect feature. In one embodiment, the second category includes three ghost defect features (first to third false defect features).

Secondly, a first deep learning model for identifying the first false defect feature is trained based on the inputted training images. When inputting the training images with the first false defect feature, the result outputted by the first deep learning model is a desired image. When the inputting training images with the defects, the result outputted by the first deep learning model is a defective image.

Thirdly, a second deep learning model for identifying the second false defect feature is trained based on the inputted training images. When inputting the training images with the second false defect feature, the result outputted by the second deep learning model is a desired image. When inputting training images with the defects, the result outputted by the second deep learning model is a defective image.

Fourthly, a third deep learning model for identifying the third false defect feature is trained based on the inputted training images. When inputting the training images with the third false defect feature, the result outputted by the third deep learning model is a desired image. When inputting training images with the defects, the result outputted by the third deep learning model is a defective image.

Therefore, the first to third learning models are trained for identifying the first to third false defect features respectively. Each model is used for identifying a particular false defect feature.

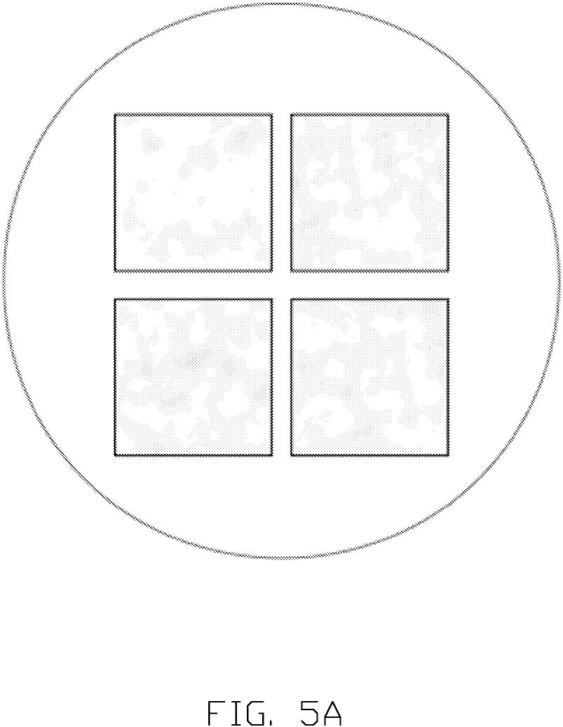

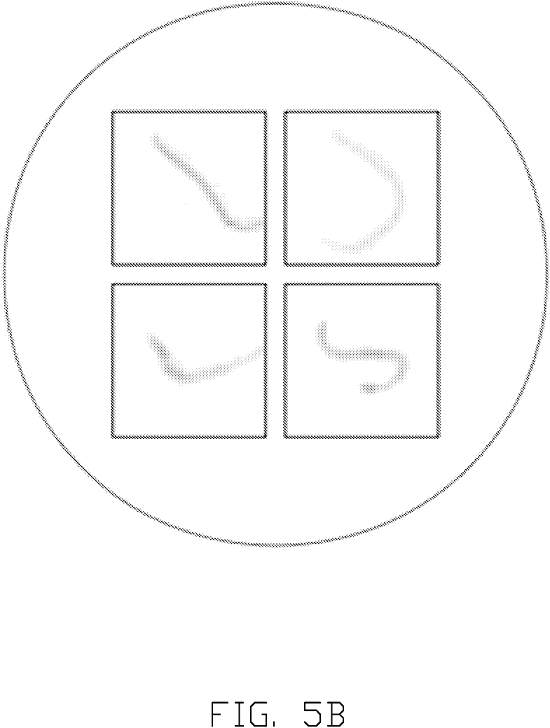

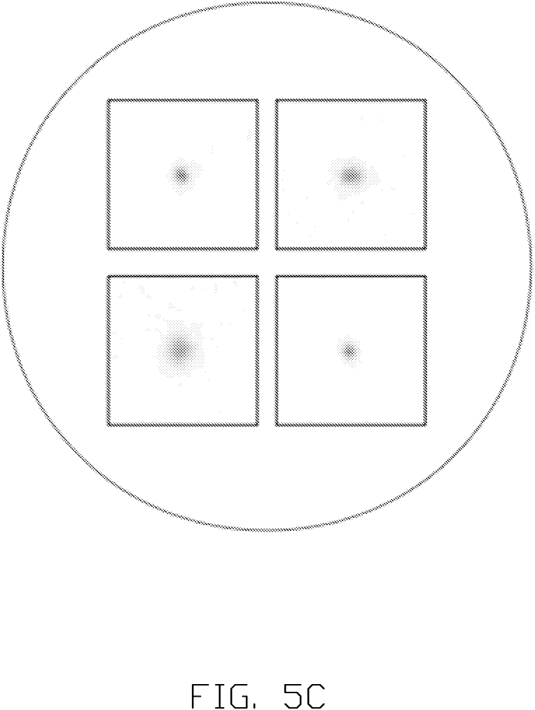

FIGS. 5A to 5C show the defective images with different features.

FIG. 5A shows the defective image with the first false defect feature A. The first false defect feature A can be noise appearing in an image perhaps because of non-even distribution of illumination. FIG. 5B shows the defective image with the second false defect feature B, the second false defect feature B can be a hair or dust in a strip shape lying on a surface of the product for example. FIG. 5C shows the defective image with defect feature C, the defect feature C is in a dot shape. There are a first and second deep learning models being trained by the training images with the first false defect feature A and the training image with the second false defect feature B.

Each deep learning model is used for identifying one specified false defect feature, a size of the training image can be reduced, and a complexity of the deep learning model is reduced, therefore a training time is reduced. Detecting defects in the images based on the above method is simpler and more convenient.

In block S262, determining whether each defect in the partial image includes a false defect feature corresponding to the Nth deep learning model. When at least one defect in the partial image includes the false defect feature corresponding to the Nth deep learning model, the partial image is a desired image detected by the Nth deep learning model. When the defect in the partial image does not include the false defect feature corresponding to the Nth deep learning model, the result outputted by the Nth deep learning model is a defective image, and the procedure goes to block S263.

In block S263, determining whether the partial image has been inputted into all the deep learning models for rechecking. When there is at least one deep learning model has not received a partial image, the N adds one and the procedure goes to the block S262. When the partial image has been inputted into all of the deep learning models for rechecking, the partial image is considered as a defective image.

The first to third deep learning models are used as examples for describing the detail of the blocks S261 to S263, as below:

In the block S261, the partial image is inputted into the first deep learning model. When the partial image includes the first false defect feature, the result outputted by the first deep learning model is a desired image, and the partial image is considered as the desired image. When the partial image does not include the first false defect feature, the result outputted by the first deep learning model is a defective image, and the procedure goes to the block S263. In the block S263, determining whether the partial image has been inputted into all of the deep learning models (the second and third deep learning models do not receive a partial image), and if so the procedure goes to the block S210.

Further, in the block S261, the partial image is inputted into the second deep learning model. When the partial image includes the second false defect feature, the result outputted by the second deep learning model is a desired image, and the partial image is considered as the desired image. When the partial image does not include the second false defect feature, the result outputted by the second deep learning model is a defective image, and the procedure goes to the block S263. In the block S263, determining whether the partial image has been inputted into all of the deep learning models (the third deep learning model does not receive a partial image), and if so the procedure goes to the block S210 again.

Further, in the block S261, the partial image is inputted into the third deep learning model. When the partial image includes the third false defect feature, the result outputted by the third deep learning model is a desired image, and the partial image is considered as the desired image. When the partial image does not include the third false defect feature, the result outputted by the third deep learning model is a defective image, and the procedure goes to the block S263. In the block S263, determining whether the partial image has been inputted into all of the deep learning models (all the first to third deep learning models receive the partial image), and if so the partial image is considered as a defective image.

Referring to FIGS. 3 and 5A-5C, details of the blocks S261 to S263 are:

The first and second partial images (cut from the original image at the block S240) are firstly rechecked by the first deep learning model in the block S261. The first and second images respectively include the positions A and B in the FIG. 3. The first deep learning model determines that both the first and second partial images fail to include the first false defect feature A, therefore the results outputted by the first deep learning model are defective images, and the procedure goes to the block S263.

Neither of the first and second partial images are input into the second deep learning model in the block S263, thus the procedure goes back to the block S261.

Further, the first and second partial images (cut from the original image at the block S240) are further rechecked by the second deep learning model in the block S261. The second deep learning model determines that the first partial image fails to include the second false defect feature B (the strip shape), the result outputted by the second deep learning model is a defective image, and the procedure goes to the block S263. When the procedure returns to the block S263, the first partial image has been inputted into the first and second deep learning models, thus the rechecking process of the first partial image has been completed. Further, the second deep learning model further determines that the second partial image includes the second false defect feature B, the result outputted by the second deep learning model is a desired image, thus the second partial image is considered as the desired image. The rechecking process of the second partial image has been completed.

Based on the above description, the first partial image is considered as the defective image, and the second partial image is considered as the desired image.

As shown in FIG. 3, the first partial image corresponding to the position A in the original image is a defective image, and the second partial image corresponding to the position B in the original image is a desired image, thus the original image is a defective image.

The standard which is used in the block S220 may cause the original image being analyzed wrongly and needs to be rechecked by the defect rechecking device 300. The present disclosure provides a plurality of deep learning models for checking different false defect features. Each deep learning model identifies one specified and particular false defect feature. When including the specified false defect feature detected by the deep learning model, the inputted partial image is a desired image. When there is no specified false defect feature detected by the deep learning model, the inputted partial image is deemed a defective image. Each deep learning model corresponds to the specified false defect feature, thus parameters for identifying a wrongly-analyzed partial image are reduced. The wrongly-analyzed partial image can be identified by the deep learning model, and the partial image is also identified as a defective image. Therefore, the ratio of misanalysis of the partial images detected by the automatic optical detection apparatus 200 is reduced. When the result outputted by one of the deep learning models is wrongly analyzed, the corresponding deep learning model can be adjusted and re-trained, and other deep learning models can operate normally.

The present disclosure provides a strict standard in the automatic optical detection apparatus 200 for detecting the appearance of defects in the original image. Then, the defective image detected by the automatic optical detection apparatus 200 is rechecked by the defect rechecking device 300. While rechecking the defective image, the partial image is inputted into different deep learning models. Each deep learning model identifies the specified and particular false defect feature. Based on the plurality of the deep learning models, the wrongly-analyzed defective images are found. Length of time for detecting the defects is reduced, and an accuracy of the detection is improved, thus an efficiency of detection is improved.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over current technologies, and to enable others of ordinary skill in the art to understand the embodiments disclosed herein.

What is claimed is:

1. A method of detecting defects in images configured for a defect detection system; the defect detection system comprises an image acquiring apparatus, an automatic optical detection apparatus, and a defect rechecking device; the method comprises:
acquiring an original image by the image acquiring apparatus;
automatically detecting the original image to determine whether the original image comprises at least one defect by the automatic optical detection apparatus, wherein when the original image comprises at least one defect, the original image is cut into at least one partial image based on a position of the at least one defect; each of the partial image contains one defect; when there is no defect in the original image, the original image is determined to be a desired image;
determining whether the at least one partial image is a desired image and outputting a result; and
determining whether the original image is a desired image based on the result.

2. The method of claim 1, the step of determining whether the corresponding original image is a desired image based on the result comprises:
determining the original image is the desired image when there are several partial images and all the partial images are determined to be the desired images; and
determining the original image to be a defective image when at least one of the partial images is a defective image.

3. The method of claim 2, wherein the step of determining whether the at least one partial image is a desired image comprises:
inputting each of the partial images into a corresponding one of the plurality of deep learning models and determining whether each of the partial images is a desired image based on a result outputted from the plurality of the deep learning models.

4. The method of claim 2, wherein each of the plurality of the deep learning models is configured for a different false defect feature; each of the deep learning models corresponds to a specified type of false defect feature.

5. The method of claim 4, wherein the step of inputting each of the partial images into a corresponding one of the plurality of deep learning models respectively and determining whether each of the partial images is a desired image based on the result outputted from the deep learning models and outputting a result comprises:
inputting one of the partial images into one of the plurality of the deep learning models to determine whether the inputted partial image comprises a specified false defect feature corresponding to the deep learning model that receives the partial image;
determining the inputted partial image to be the desired image in the corresponding deep learning model if the inputted partial image comprises the specified false defect feature corresponding to the deep learning model that receives the partial image;
determining the inputted partial image to the defective image if the inputted partial image does not comprise the false defect feature, and determining whether the partial image has been inputted into all of the plurality of the plurality of the deep learning models;
inputting the partial image into another one of the plurality of deep learning models to determine whether the inputted partial image comprises the specified false defect feature corresponding to the deep learning model that receives the partial image if there is at least one deep learning model has not received the partial image; and
outputting the result when the partial image has been inputted into all of the plurality of the deep learning models.

6. The method of claim 5, wherein if the partial image is determined to be the defective image by at least one of the plurality of the deep learning models, the result is a defective image; and if partial image is determined to be the desired image by all of the plurality of the deep learning models, the result is a desired image.

7. The method of claim 1, before the step of the determining whether the at least one partial image is a desired image and outputting a result, the method further comprises:
pre-processing the at least one partial image for enlargement.

8. A defect detection system comprising:
an image acquiring apparatus acquires an original image;
an automatic optical detection apparatus automatically detects the original image for determining whether the original image comprises at least one defect; wherein when there is no defect in the original image, the original image is determined to be a desired image; and
a defect rechecking device receives the original image from automatic optical detection apparatus when the original image comprises at least one defect; the defect rechecking device cuts the original image into at least one partial image based on a position of the at least one defect; each of the partial image contains one defect; the defect rechecking device determines whether the at least one partial image is a desired image and outputting a result; the defect rechecking device further determines whether the original image is a desired image based on the result.

9. The defect detection system of claim 8, wherein when there are several partial images and all the partial images are determined to be desired images, the defect rechecking device considers the original image as the desired image; when at least one of the partial images is a defective image, the defect rechecking device determines the original image to be a defective image.

10. The defect detection system of claim 9, wherein the defect rechecking device inputs each of the partial images into a plurality of deep learning models and determines whether the inputted partial image is a desired image based on a result outputted from the plurality of the deep learning models.

11. The defect detection system of claim 10, wherein each of the plurality of the deep learning models is configured for a different false defect feature; each of the deep learning models corresponds to a specified type of false defect feature.

12. The defect detection system of claim 11, wherein the defect rechecking device inputs one of the partial images into one of the plurality of the deep learning models to determine whether the inputted partial image comprises a specified false defect feature corresponding to the deep learning model that receives the partial image; the defect rechecking device determines the inputted partial image to be the desired image in the corresponding deep learning model if the inputted partial image comprises the specified false defect feature corresponding to the deep learning model that receives the partial image; the defect rechecking device determines the inputted partial image to be the defective image if the inputted partial image does not comprise the false defect feature, and determines whether the partial image has been inputted into all of the plurality of the deep learning models; the defect rechecking device inputs the partial image into another one of the plurality of deep learning models to determine whether the inputted partial image comprises the specified false defect feature corresponding to the deep learning model that receives the partial image if there is at least one deep learning model has not received the partial image; the defect rechecking device outputs the result when the partial image has been inputted into all of the plurality of the deep learning models.

13. The defect detection system of claim 12, wherein if the partial image is determined to be the defective image by at least one of the plurality of the deep learning models, the result is a defective image; if partial image is determined to be the desired image by all of the plurality of the deep learning models, the result is a desired image.

14. The defect detection system of claim 8, wherein the defect rechecking device further pre-processes the partial image for enlargement.
